(19) United States
(12) Patent Application Publication
(10) Pub. No.: US 2003/0223808 A1
(43) Pub. Date: Dec. 4, 2003

(54) Length-adjusting device for elastic cord member

(76) Inventors: Johnson Kuo, Taipei (TW); Chin-Lien Huang, Taichung (TW)

Correspondence Address: BACON & THOMAS, PLLC, 625 SLATERS LANE, FOURTH FLOOR, ALEXANDRIA, VA, 22314

(21) Appl. No.: 10/196,187

(22) Filed: Jul. 17, 2002

(30) Foreign Application Priority Data
May 28, 2002 (TW) 91207767

(51) Int. Cl. F16D 1/00

(52) U.S. Cl. 403/220

(57) ABSTRACT

A length-adjusting device for an elastic cord member is formed of a block body for the fastening of the elastic cord member. The block body has a first tunnel, a second tunnel and a third tunnel for enabling the elastic cord member to be inserted with one end thereof through the first tunnel and then detoured and inserted through the second tunnel and then detoured and inserted through the third tunnel and extended out of the third tunnel at a distance.

### BACKGROUND OF THE INVENTION

1. Field of the Invention

The present invention relates to a length-adjusting device adapted for adjustably fastening an elastic cord member to an object and, more particularly, to such a length-adjusting device, which is easy to install and inexpensive to manufacture.

2. Description of the Related Art

Elastic cord members are springy, and intensively used in motorcycles for fastening things. Recently, elastic cord members are commonly used in exercising apparatus. When in use, an elastic cord member may be matched with a length-adjusting device so that the user can conveniently adjust the length of the elastic cord member. FIG. 1 is a perspective view of a length-adjusting device according to the prior art. FIG. 2 shows an application example of the prior art length-adjusting device. This structure of length-adjusting device 90 is comprised of a mounting block 91, and a cord member clamp 92. The mounting block 91 comprises two through holes 911, 911′, a hook 912 extended from the periphery, and a pin 913 pivoted to the free end of the hook 912. By means of the hook 912 and the pin 913, the mounting block 91 can be conveniently fastened to, for example, one handle 941 of an exercising apparatus 94. The cord member clamp 92 is comprised of a top clamping shell 921 and a bottom clamping shell 922. The clamping shells 921, 922 are detachably fastened together. When fastened together, the clamping shells 921, 922 define two insertion holes 923. The elastic cord member 93 is inserted through the through holes 911, 911′, and then secured to the insertion holes 923 of the cord member clamp 921. The cord member clamp 921 further comprises a plurality of conical teeth (not shown) formed integral with the clamping shells 921, 922 and adapted to stop the elastic cord member 93 from movement relative to the cord member clamp 921. This design of length-adjusting device is still not satisfactory in function and, has drawbacks as outlined hereinafter:

1. The installation of this design of length-adjusting device is complicated. When in use, the user must insert one end of the elastic cord member 93 through one through hole 911 of the mounting block 91, and then turned into a U-turn, and then inserted through the other through hole 911′. When adjusted to the desired length, the main section and endpiece of the elastic cord member 93 are respectively put in between the clamping shells 921, 922, and then the clamping shells 921, 922 are fastened together to hold down the main section and endpiece of the elastic cord member 93 in the insertion holes 931.

2. The manufacturing cost of this design of length-adjusting device is high. Because the mounting block 91 comprises two through holes 911, 911′, a hook 912, and a pin 913 and the cord member clamp 92 is formed of a top clamping shell 921 and a bottom clamping shell 922, the manufacturing cost of the length-adjusting device is high.

### SUMMARY OF THE INVENTION

The present invention has been accomplished to provide a length-adjusting device, which eliminates the aforesaid drawbacks. It is therefore the main object of the present invention to provide a length-adjusting device, which is easy to install.

It is another object of the present invention to provide a length-adjusting device, which is inexpensive to manufacture.

To achieve these objects of the present invention, the length-adjusting device is formed of a block body for the fastening of an elastic cord member. The block body has a first tunnel, a second tunnel and a third tunnel for enabling the elastic cord member to be inserted with one end thereof through the first tunnel and then detoured and inserted through the second tunnel and then detoured and inserted through the third tunnel and extended out of the third tunnel at a distance.

### BRIEF DESCRIPTION OF THE DRAWINGS

FIG. 1 is a perspective view of a length-adjusting device according to the prior art.

FIG. 2 shows an application example of the prior art length-adjusting device.

FIG. 3 is a perspective view of a length-adjusting device according to a first embodiment of the present invention.

FIG. 4 is a sectional view taken along line 4-4 of FIG. 3.

FIG. 5 is a side view of the length-adjusting device according to the first embodiment of the present invention.

FIG. 6 is an installed view of the length-adjusting device according to the first embodiment of the present invention, showing the elastic cord member inserted through the tunnels of the block body.

FIG. 7 is an applied view of the present invention, showing the length-adjusting device of the first embodiment of the present invention used in an exerciser.

FIG. 8 is a perspective view of a length-adjusting device according to a second embodiment of the present invention.

FIG. 9 is a sectional view taken along line 9-9 of FIG. 8.

FIG. 10 is a longitudinal view in section of a length-adjusting device according to a third embodiment of the present invention.

FIG. 11 is a perspective view of a length-adjusting device according to a fourth embodiment of the present invention.

FIG. 12 is a sectional view taken along line 12-12 of FIG. 11.

FIG. 13 is a longitudinal view in section of a length-adjusting device according to a fifth embodiment of the present invention.

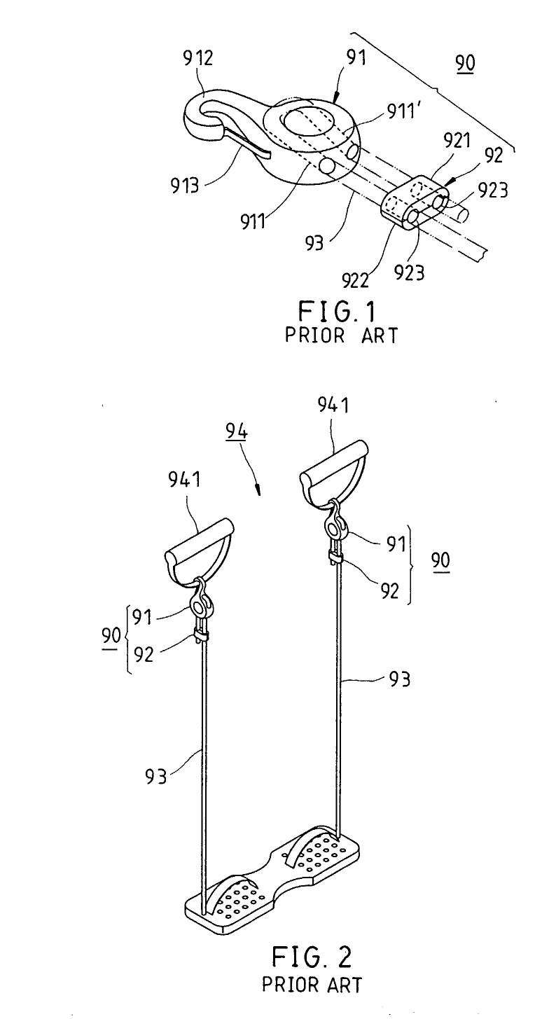

### DETAILED DESCRIPTION OF THE PREFERRED EMBODIMENT

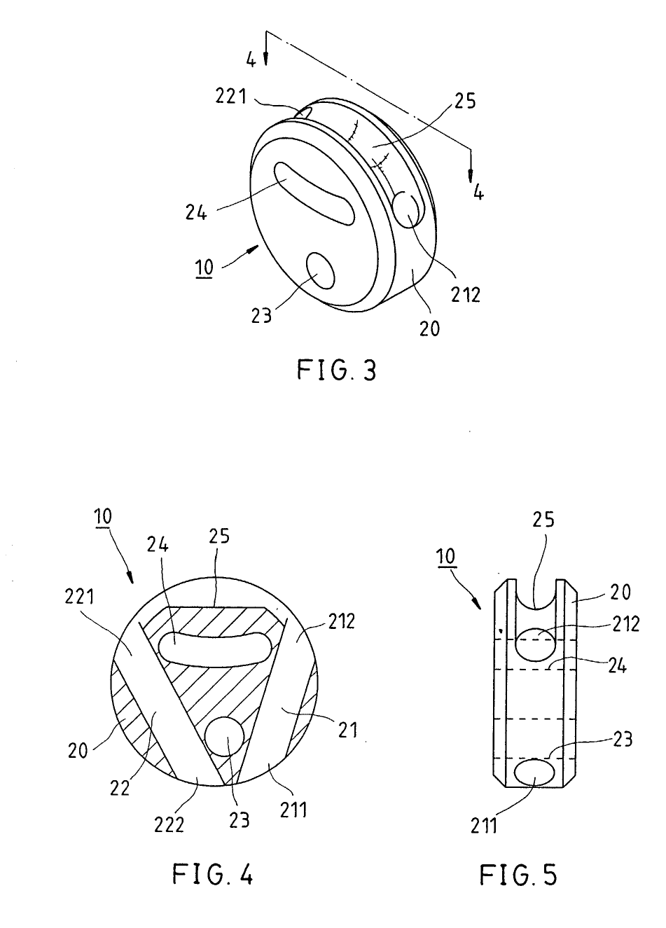

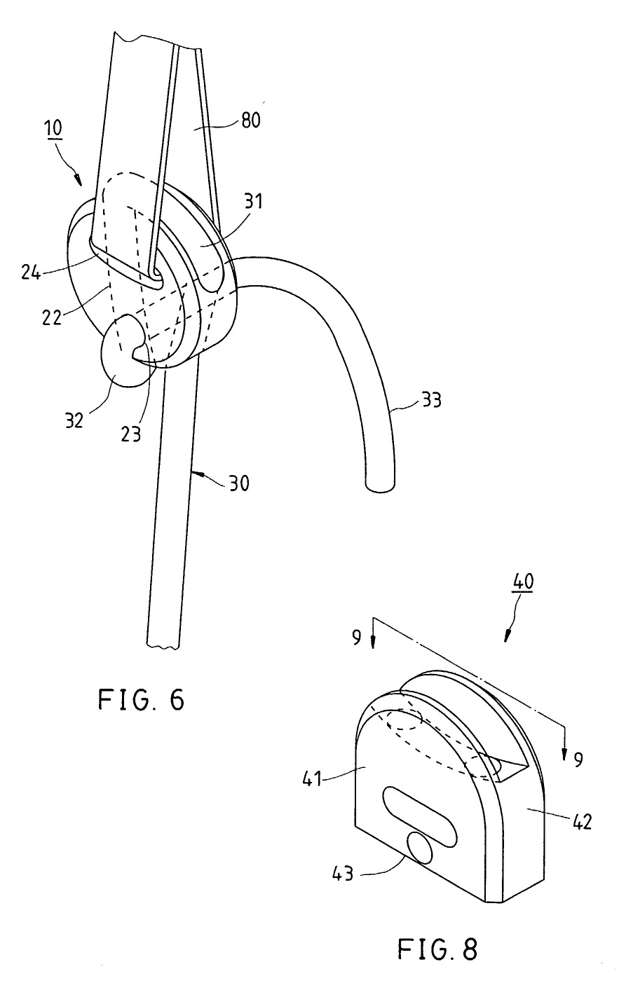

Referring to FIGS. 3˜5, a length-adjusting device 10 provided by a first preferred embodiment of the present invention is shown comprising a block body 20 shaped like a circular block. The block body 20 has a first tunnel 21, a second tunnel 22, a third tunnel 23, an elongated slot 24, and a peripheral groove 25. The first tunnel 21 and the second tunnel 22 are radially disposed at two sides of the center of the block body 20. The pitch between the first end 211 of the first tunnel 21 and the second end 222 of the second tunnel 22 is shorter than the pitch between the second end 212 of the first tunnel 21 and the first end 221 of the second tunnel 22, therefore the first tunnel 21 and the second tunnel 22 show a substantially V-shaped arrangement. The peripheral groove 25 is connected between the second end 212 of the first tunnel 21 and the first end 221 of the second tunnel 22. The third tunnel 23 and the elongated slot 24 are disposed between the first tunnel 21 and the second tunnel 22 in parallel to the axis of the block body 20 (i.e., the axes of the first tunnel 21 and second tunnel 22 are on a first plane, and the axis of the third tunnel 23 is on a second plane substantially perpendicular to the first plane).

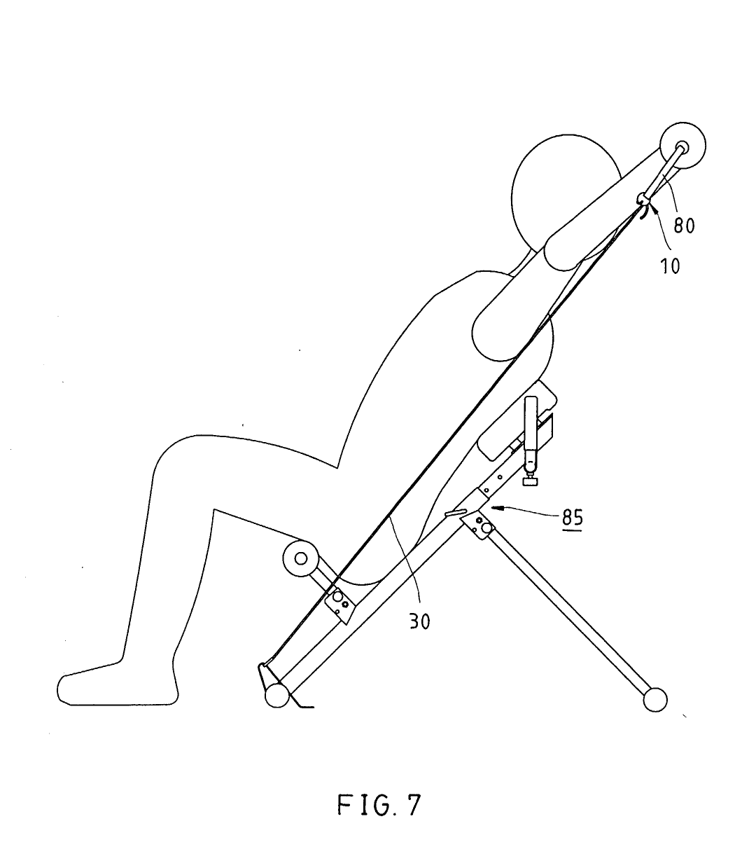

Referring to FIG. 6 and FIG. 4 again, the elastic cord member 30 is inserted through the first end 211 and second end 212 of the first tunnel 21, and then extended over the peripheral groove 25, and then turned backwards and inserted through the first end 221 and second end 222 of the second tunnel 22, forming a first turn 31 at the peripheral groove 25, and then turned upwards and inserted through the third tunnel 23, forming a second turn 32. The endpiece 33 of the elastic cord member 30 extends out of the third tunnel 23 at a predetermined distance. The first turn 31 and second turn 32 of the elastic cord member 30 produce a friction resistance when the elastic cord member stretched, keeping the block body 20 firmly secured to the elastic cord member 30. A belt 80 is fastened to the elongated slot 24 for the gripping of the hand, or for hanging on an object. FIG. 7 shows an application example of the present invention. As illustrated, the elastic cord member 30 has one end fixedly fastened to the exerciser 85 and the other end fastened to the length-adjusting device 10, and the player holds the belt 80 of the length-adjusting device 10 to exercise the muscles of the arms. Further, the length-adjusting device 10 can be made having a hook and a spring latch for fastening.

The design of the peripheral groove 25 enables the elastic cord member 30 to be received in one side of the block body 20 to maintain the sense of beauty of the length-adjusting device 10. The peripheral groove 25 can be a straight groove connected between the first tunnel 21 and the second tunnel 22, forming a respective turn at each of the first and second tunnels 21, 22 to enhance the friction resistance between the elastic cord member 30 and the block body 20.

As indicated above, the length-adjusting device achieves the following advantages.

1. One single block design for quick installation. Because the length-adjusting device is a single block, the user can easily fasten an elastic cord member to the length-adjusting device and conveniently adjust the elastic cord member to the desired length.

2. Because the length-adjusting device is formed of a single block, the manufacturing cost of the length-adjusting device is low.

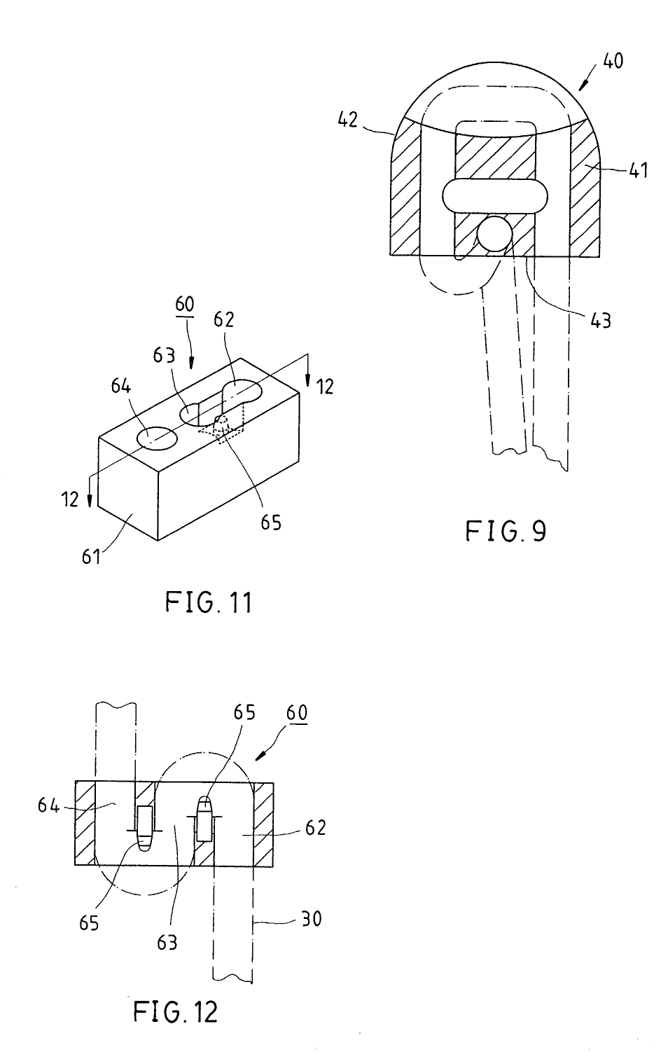

FIGS. 8 and 9 show a length-adjusting device according to a second preferred embodiment of the present invention. According to this embodiment, the block body 41 of the length-adjusting device 40 has a smoothly arched peripheral section 42 and a straight peripheral section 43 connected between two distal ends of the smoothly arched peripheral section 42. Actually, the block body can be variously shaped, for example, the block body can be shaped like a square block, rectangular block, trapezoidal block, oval block, etc.

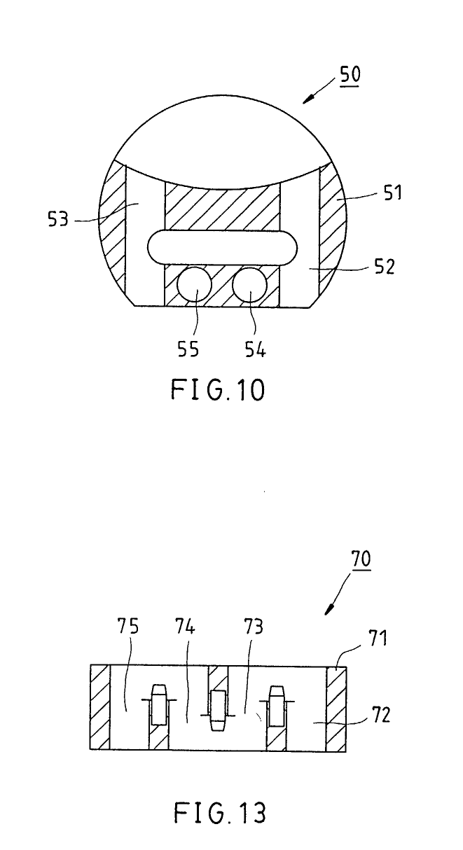

Further, the number of tunnels of the block body is not limited to three. FIG. 10 shows a length-adjusting device according to a third preferred embodiment of the present invention. In addition to the first, second and third tunnels 52, 53 and 54, the block body 51 of the length-adjusting device 50 further comprises a fourth tunnel 55 adjacent to the third tunnel 54 for the passing and positioning of the endpiece of the elastic cord member.

FIGS. 11 and 12 show a length-adjusting device according to a fourth preferred embodiment of the present invention. According to this embodiment, the block body 61 of the length-adjusting device 60 is a rectangular block, and the first tunnel 62 and the third tunnel 64 are arranged in parallel and spaced from the second tunnel 63 at two sides, i.e., the longitudinal axes of the first tunnel 62, second tunnel 63 and third tunnel 64 are disposed on one plane and approximately in parallel to one another. When inserted through the tunnels 62, 63, 64, the elastic cord member 30 shows a substantially S-shaped profile. Further, the block body 61 comprises at least one conical tooth 65 disposed in each detour for enhancing the positioning of the elastic cord member 30 in the block body 61.

In the aforesaid first embodiment of the present invention, the first tunnel and the second tunnel are disposed on a first plane, and the third tunnel is disposed on a second plane. In the aforesaid fourth embodiment of the present invention, the first, second and third tunnels are disposed on one plane. Alternatively, the block body can be made having the three tunnels respectively disposed on different planes.

FIG. 13 shows a length-adjusting device according to a fifth preferred embodiment of the present invention. In addition to the first, second and third tunnels 72, 73, 74, the block body 71 of the length-adjusting device 70 further comprises a fourth tunnel 75 for the passing and positioning of the endpiece of the elastic cord member.

What the invention claimed is:

1. A length-adjusting device adapted to be coupled with an elastic cord member, the length-adjusting device comprising:
a block body having a first tunnel and a second tunnel for enabling the elastic cord member to be inserted with one end thereof through said first tunnel and then detoured and inserted through said second tunnel;
wherein said block body further comprises a third tunnel for the passing of the end of said elastic cord member being inserted through said first tunnel and said second tunnel.

2. The length-adjusting device as claimed in claim 1, wherein said first tunnel and said second tunnel are disposed at two sides relative to the geometric center of said block body; the longitudinal axes of said first tunnel and said second tunnel are substantially disposed on one plane; said third tunnel is spaced between said first tunnel and said second tunnel and extended in a direction where the longitudinal axis of said third tunnel is substantially perpendicular to said plane.

3. The length-adjusting device as claimed in claim 2, wherein said block body further comprises a fourth tunnel spaced between said first tunnel and said second tunnel and extended in a direction where the longitudinal axis of said fourth tunnel is disposed substantially in parallel to said third tunnel.

4. The length-adjusting device as claimed in claim 1, wherein said block body further comprises an elongated slot.

5. The length-adjusting device as claimed in claim 1, wherein said first tunnel and said third tunnel are substantially arranged in parallel and spaced from said second tunnel at two sides.

6. The length-adjusting device as claimed in claim 5, wherein said block body further comprises a fourth tunnel; said first tunnel, said second tunnel, said third tunnel and said fourth tunnel have the respective longitudinal axes substantially arranged in parallel.

7. The length-adjusting device as claimed in claim 1, wherein said block body further comprises a peripheral groove extended between one end of said first tunnel and one end of said second tunnel.

8. The length-adjusting device as claimed in claim 1, wherein said block body further comprises at least one conical tooth disposed between one end of said first tunnel and one end of said second tunnel.
